(19) United States
(12) Patent Application Publication
(10) Pub. No.: US 2004/0111876 A1
(43) Pub. Date: Jun. 17, 2004

(54) Reworking device for removing electrical elements mounted on motherboard

(76) Inventor: Andrew Cheng, Diamond Bar, CA (US)

Correspondence Address: Andrew Cheng, 22928 Estoril Drive #5, Diamond Bar, CA, 91765, US

(21) Appl. No.: 10/318,958

(22) Filed: Dec. 13, 2002

(51) Int. Cl. B23P 19/00; H01R 3/00

(52) U.S. Cl. 29/762; 29/764; 29/840

(57) ABSTRACT

A reworking device (10) for removing a socket connector (20) soldered to a PCB (40) comprises a body portion (12) and a pair of movable clips (16) assembled to the body portion. Each of the movable clips has a hook (16f) for hooking a portion of the socket connector. A spring (16e) is compressively mounted on each of the movable clips for providing an upward force to the hook to pull the socket connector upwardly from the PCB when a soldering connection between the PCB and the socket connector is heated to reflow. A pair of standing legs (14) is provided to stand on an upper surface of the PCB beside the socket connector. The body portion is mounted on the standing legs.

### CROSS-REFERENCE TO RELATED APPLICATION

This patent application is a Co-pending application of patent application Ser. No. 10/170,989, entitled “REWORKING DEVICE FOR REMOVING ELECTRICAL ELEMENTS MOUNTED ON MOTHERBOARD”, filed on Jun. 11, 2002, invented by the same inventors and assigned to the same assignee as this patent application.

### BACKGROUND OF THE INVENTION

1. Field of the Invention

The present invention relates to a reworking device, and more particularly to a reworking device for lifting an electrical element from a motherboard to which the electrical element is soldered to thereby remove the electrical element from the motherboard.

2. Description of Prior Art

Surface mounted electronic elements have become a trend in computer industry, since they have a number of advantages over through hole mounted elements. For example, a socket connector for electrically connecting a central processing unit (CPU) to a motherboard has been evolved from pin grid array (PGA) to ball grid array (BGA) so as to benefit the advantages of SMT, such as automatic mounting of the connector on the motherboard.

However, one problem associated with the BGA socket connector and other surface mounted elements is how to remove the mounted BGA socket connector or the like from the motherboard when the connector or the like or the connection thereof with the motherboard is found defective.

As a matter of fact, a typical BGA socket connector generally includes more than four hundred solder balls arranged in a matrix covering a entire bottom surface of the connector. For the PGA socket connector, the rework thereof, i.e., removing the mounted PGA socket connector from the motherboard, can be done by reflowing the solders located between the pin legs of the socket connector and the through holes in the motherboard and access them from the bottom of the motherboard. However, for the BGA socket connector, it is unlikely to access the solder balls located under the socket connector and apply heat to the solders to reflow them thereby separating the BGA socket connector from the motherboard.

Once the mounted BGA socket connector or the like or the soldering thereof to the motherboard is found detective, the connector or the like together with the mother board has to be thrown away. For a reference, the estimated cost for a motherboard is at least US $50 and even more for high-end motherboard. The throw away of the entire motherboard only because of a defective element thereof or a defective soldering of an element thereof inevitably increases the overall manufacturing cost.

In order to remove the mounted BGA socket connector or the like from the motherboard, a main problem to be solved is how to effectively apply a uniform pulling force to the connector once a soldering connection of the connector with the motherboard is released.

### SUMMARY OF THE INVENTION

An objective of the present invention is to provide a reworking device which can lift a BGA socket connector mounted on a motherboard such that the BGA socket connector is completely detached from the motherboard once solder balls of the connector are heated to reflow.

A further objective of the present invention is to provide a reworking device which can lift a BGA socket connector mounted on a motherboard effectively without damaging the motherboard.

In order to achieve the objectives set forth above, a reworking device for removing a surface mounted socket connector from a motherboard comprises an elongate body portion, a pair of standing legs and a pair of movable clips. The standing legs are set on the motherboard beside the socket connector. The elongate body portion is mounted on the standing legs and located above the socket connector. Each of the movable clips is hanged on an end of the body portion and includes a hook at a bottom end thereof engaging with the socket connector. Each movable clip has a spring. The springs can expand to activate the movable clips to move upwardly, thereby to pull the socket connector upwardly from the motherboard, when a soldering connection between the socket connector and the motherboard is heated to reflow. Thus, the socket connector is separated from the motherboard.

Other objectives, advantages and novel features of the invention will become more apparent from the following detailed description of the preferred embodiment when taken i0n conjunction with the accompanying drawings.

### BRIEF DESCRIPTION OF THE DRAWINGS

FIG. 1 is a top view of a reworking device of the present invention;

FIG. 2 is a cross-sectional view of the reworking device of FIG. 1 and a socket connector and a printed circuit board (PCB) on which the connector and the reworking device are mounted; and

FIG. 3 is a view similar to FIG. 2, showing the reworking device being activated to lift the socket connector from the PCB.

### DETAILED DESCRIPTION OF THE INVENTION

Reference will now be made to the drawing figures to describe the present invention in detail.

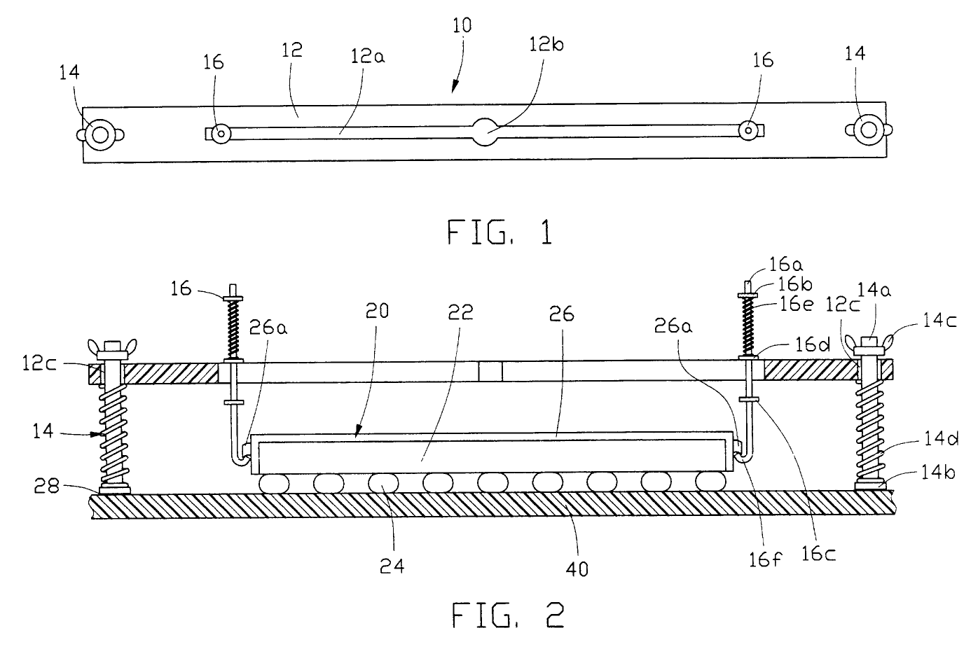

Referring to FIGS. 1 and 2, a reworking device 10 of the present invention is used to separate a surface mounted BGA (Ball Grid Array) socket connector 20 or the like from a printed circuit board (PCB) 40 which usually is a motherboard. The socket connector 20 includes a rectangular base 22 and a cover 26 slidably mounted on the base 22. A plurality of solder balls 24 arranged in a matrix is attached on a bottom face of the base and soldered to the PCB 40. The solder balls 24 are attached to bottom ends of conductive terminals (not shown) of the socket connector 20. The cover 26 includes a pair of protrusions 26a at opposite sides thereof.

The reworking device 10 includes an elongate body portion 12, a pair of standing legs 14 downwardly located at two opposite ends of the elongate body portion 12, and a pair of movable clips 16 movably assembled to the body portion 12 and engaging with the protrusions 26a of the socket connector 20. The elongate body portion 12 defines an elongate slot 12a longitudinally extended therealong, and an enlarged round hole 12b at a middle of the elongate slot 12a. The elongate body portion 12 further defines a receiving hole 12c in each of the two opposite ends thereof. Each of the standing legs 14 includes a post 14a, an enlarged portion 14b at a bottom end of the post 14a abutting against the PCB 40, and a screw (not shown) is formed on an upper end of the post 14a. A nut 14c is screwed downward along the screw of the post 14a of the standing leg 14 and a first spring 14d is located surrounding the post 14a. The first spring 14d has a top end abutting against a bottom face of the elongate body portion 12 and a bottom end abutting against a top face of the enlarged portion 14b of the standing leg 14. In addition, a soft pad 28 is provided on a bottom face of each of the enlarged portions 14 so that the soft pads 28 are located between the enlarged portions 14b and the PCB 40. Each of the movable clips 16 includes a straight pole 16a, a first washer 16b fixed at an upper portion of the pole 16a, a second washer 16c fixed at a lower portion of the pole 16a, and a third washer 16d assembled to the pole 16a between the first and second washers 16b, 16c and being able to move along the pole 16a. Each washer 16b, 16c, 16d has a diameter which is larger than a width of the slot 12a, but smaller than that of the enlarged hole 12b of the elongate body portion 12. A second spring 16e surrounds the pole 16a between the first and third washers 16b, 16d. Each of the movable clips 16 includes a hook 16f at a bottom end thereof.

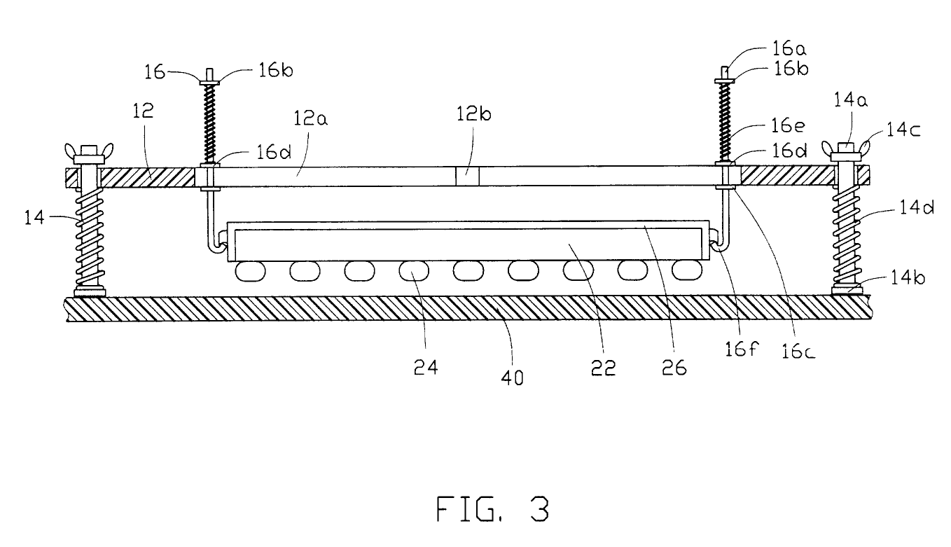

Also referring to FIG. 2, in use, first, the standing legs 14 are located beside the socket connector 20 which is mounted on the PCB 40 and is to be removed therefrom since an incorrect soldering exists between the connector 20 and the PCB 40. The first springs 14d are brought to surround the posts 14a of the standing legs 14, and the nuts 14c are not screwed onto the posts 14a. The movable clips 16 are then assembled to the elongate body portion 12 through the enlarged hole 12b and moved to two opposite ends of the slot 12a. The third and the second washers 16d and 16c are located respectively at above and below the body portion 12. Thereafter, the elongate body portion 12 with the movable clips 16 is attached to the standing legs 14 with the posts 14a of the standing legs 14 extending through the receiving holes 12c of the elongate body portion 12 and the elongate body portion 12 abutting against a top end of the first springs 14d. The nuts 14c are screwed to the posts 14a of the standing legs 14 to secure the elongate body portion 12 to the standing legs 14. The movable clips 16 are then downwardly pressed enable the hooks 16f to firmly engage with the protrusions 26a of the socket connector 20. The second springs 16e are thus compressed to provide the socket connector 20 an upward force through the hooks 16f of the poles 16a. Finally, the socket connector 20, the reworking device 10 and the PCB 40 are together moved through an oven (not shown) to soften the solder balls 24 between the socket connector 20 and the PCB 40. When the solder ball 24 are sufficiently heated to reflow, the socket connector 20 is pulled up by the expansion force of the springs 16e. Thus, the incorrectly mounted socket connector 20 is removed from the PCB 40. The movable clips 16 pull the socket connector 20 upwardly until the second washers 16c are stopped by the body portion 12 as shown in FIG. 3.

It is noted that the present invention can be also used to remove other electrical elements mounted on the PCB 50 by through hole soldering.

A first advantage of the present invention is that the reworking device can lift the socket connector such that the socket connector is completely detached from the PCB once the solder balls are heated to reflow.

A second advantage of the present invention is that the reworking device lift the socket connector uniformly and without damaging the PCB.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A reworking device for removing an electrical element soldered to a PCB from the PCB, comprising:
a body portion arranged above the electrical element;
a pair of standing legs for being located on the PCB and supporting two opposite ends of the body portion; and
a pair of movable clips movably assembled to the body portion, each movable clip forming a hook for hooking with the electrical element; wherein
the movable clips have resilient members which can exert an upward force to the electrical element so that when a soldering connection between the electrical element and the PCB is heated to reflow, the electrical element is pulled upwardly by the movable clips to separate from the PCB.

2. The reworking device as claimed in claim 1, wherein the hook is formed at a bottom end of the each of the movable clips for hooking at a protrusion formed at each of two opposite sides of the electrical element.

3. The reworking device as claimed in claim 1, wherein the body portion defines a receiving hole at each of two opposite ends thereof and each standing leg includes a post extending through a corresponding through hole.

4. The reworking device as claimed in claim 3, wherein the each of the standing legs includes an enlarged portion at a bottom end thereof for abutting against an upper surface of the PCB.

5. The reworking device as claimed in claim 4, wherein a spring is assembled to a corresponding post between the body portion and a corresponding enlarged portion of the standing leg.

6. The reworking device as claimed in claim 4, wherein a soft pad is located between the corresponding enlarged portion and the PCB.

7. The reworking device as claimed in claim 1, wherein the body portion defines an elongate slot and each of the movable clips includes a pole through the slot.

8. The reworking device as claimed in claim 7, wherein each of the movable clips includes a first washer fixed at an upper portion of the pole, a second washer fixed at the pole between the first washer and the hook and below the body portion, each of the resilient members being a spring assembled to the pole and compressed between the first washer and the body portion.

9. The reworking device as claimed in claim 8, wherein a third washer is movably mounted to the pole and located between the spring and the body portion.

10. A reworking device for removing an electrical connector from a PCB to which the electrical connector is soldered, comprising:
a pair of legs standing on the PCB and beside the connector, each leg having a first spring thereon;
a body portion mounted on the first springs of the legs and above the electrical connector;
at least a clip hanged on the body portion and having a bottom end engaging with the electrical connector, a second spring compressed between the body portion and an upper end of the at least a clip, the second spring exerting an upwardly pulling force to the connector via the bottom end of the at least a clip.

11. In combination,
a printed circuit board with an electronic component soldered thereon;
a reworking device including a body portion seated upon the printed circuit board via at least one leg portion, thus spacing away from said printed circuit board with a constant distance, and a clip being moveable relative to the body portion at least along a vertical direction, a biasing device urging said clip to move upwardly; wherein
said clip defines a grasping section engaged with the electronic component, so that once the electronic component is unsoldered, the electronic component is raised upwardly away from the printed circuit board by said biasing device while the body portion is still located at substantially the same vertical position relative to the printed circuit board.
